(19) United States
(12) Patent Application Publication
(10) Pub. No.: US 2011/0145385 A1
(43) Pub. Date: Jun. 16, 2011

(54) REMOTE MANAGEMENT SYSTEM AND THE METHOD THEREOF

(75) Inventor: Yi-Li Liu, DELTA (CA)

(73) Assignee: ATEN INTERNATIONAL CO., LTD., Taipei (TW)

(21) Appl. No.: 12/969,509

(22) Filed: Dec. 15, 2010

(30) Foreign Application Priority Data
Dec. 16, 2009 (TW) 098143249

(51) Int. Cl. G06F 15/173

(52) U.S. Cl. 709/223

(57) ABSTRACT

A remote management system comprises a remote management device, a first management computer and a second management computer, a first management program and a second management program. The remote management device includes a network interface and a computer interface connected to at least one controlled computer, and converts an image signal output by the at lest one controlled computer into a network packet. The first and second management programs respectively cause the first and second computers to output their respective control signals and perform their respective management functions for establishing a network connection between them and the remote management device through a first network and the network interface, and transmitting their respective control signal to the remote management device via the first network for managing the at least one controlled computer. One of the first and second management computers is selected as a repeater for receiving the network packet from the remote management device and forwarding the network packet to the other one of the first and second management computers via a second network.

### BACKGROUND OF THE INVENTION

1. Field of the Invention

The present invention relates to a remote management system, and more particularly to a remote management system with a keyboard-Video-Mouse (KVM) switch.

2. Description of Related Art

Referring to FIG. 1, there is shown a scheme of a KVM over IP system known in this field, including a typical remote management device which is a KVM over IP device 110 connected to a plurality of controlled computers 111-113 via the computer interface thereof, and also connected to a plurality of management computers 13-15 via the network interface thereof through a network 120. Using the first management computer 13 as an example for description, each management computer set usually includes a computer mainframe 131, a display monitor 132, a keyboard 133 and a mouse 134. The basic function of the KVM over IP device 110 is to transmit the control command K/M by the respective management computer 13, 14 or 15 form the keyboard or mouse to the controlled computers 111-113 via the network 120, so as to command the controlled computer that is selected, such as the controlled computer 111 in FIG. 1.

The controlled computer 111 which receives the control command will, according to the command, transmit the information, such as an image signal, required by the management computer 13, 14 or 15 through the computer interface to the KVM over IP device 110 which will convert the image signal into a network packet, and transmit the network packet to the management computer 13, 14 or 15 that have issued the requests through the network 120. Finally, the image signal will be processed by the management computer and shown on the display monitor 132.

As shown in FIG. 1, if the management computers 13, 14 and 15 request the same image signal from the KVM over IP device 110 at the same time, i.e., the management computers 13, 14 and 15 are connected to the same port of the KVM over IP device 110, the same image signal has to be transmitted to the respective management computers 13, 14 and 15 by the KVM over IP device 110 at the same time. On this condition, the KVM over IP device 110 needs to receive an image signal from the controlled computer 111 over the path shown by the dotted line (1), and after converting the image signal into the network packet, transmit the same network packet to the respective management computers 13, 14 and 15 through the network 120 over three paths shown by the dotted lines (2). For the KVM over IP device 110, there is no difference between the bandwidth of the network required to repeatedly transmit the same network packet and that required to transmit different network packets. This means that more management computers served by the KVM over IP device 110 will cause a larger load of the KVM over IP device 110.

Therefore, the present invention is designed to provide a remote management system and the method thereof to effectively overcome the drawbacks of the above discussed prior arts.

### SUMMARY

The present invention is directed to a remote management system and method using one of a plurality of management computer to forward the image signal for reducing the loading of the output bandwidth of a KVM over IP device.

In an arrangement of a KVM over IP system, it is a common phenomenon that multiple management computers access the same image signal via a remote management device such as a KVM over IP device at the same time. In this situation, if one of the management computers could play the role of a relay repeater for forwarding the received image signal (such as the network packet converted from the image signal) to the other management computers after receiving the image signal from the remote management device, the remote management device is not required to transmit the same network packet of the image signal repeatedly. Accordingly, the output bandwidth of the remote management device can be used more effectively, and the efficiency of transmitting the information will be increased.

One purpose of the present invention is to provide a method for transmitting image signals, in which the performance and the resource that the management computer possesses are fully utilized. Since it is no longer necessary for the remote management device to transmit the same message to different management computers, the output bandwidth required by the remote management device could be reduced and the transmission efficiency of the information of the system could be increased.

The additional features and advantages of the present invention will be described in the following descriptions, which could be recognized definitely through the descriptions or through implementing the present invention. The purpose and other advantages of the present invention could be obtained from the specification, claims and figures.

In order to achieve the abovementioned purpose, the present invention provides a remote management system. The remote management system comprises a remote management device, a first management program, and a second management program. The remote management device includes a network interface and a computer interface connected to at least one controlled computer, and converts an image signal output by the at least one controlled computer through the computer interface into a network packet. The first management program is executed on a first management computer so that the first management computer can output a first control signal and performs a first management program for establishing a network connection between the first management computer and the remote management device through a first network and the network interface, and transmitting the first control signal to the remote management device via the first network for managing the controlled computer. The second management program is executed on a second management computer so that the second management computer can output a second control signal and performs a second management program for establishing a network connection between the second management computer and the remote management device through the first network and the network interface, and transmitting the second control signal to the remote management device via the first network for managing the controlled computer. One of the first and second management computers is selected as a repeater for receiving the network packet from the remote management device and forwarding the network packet to the other one of the first and second management computers via a second network.

In accordance with another aspect of the present invention, a remote management method is provided.

In accordance with another aspect of the present invention, a remote management method is provided, which comprises steps of: (a) connecting at least one controlled computer to a remote management device; (b) coupling a first management computer and a second management computer to the remote management device via a first network, and managing the controlled computer by the first management computer and the second management computer through the remote management device; (c) selecting one of the first and second management computers as a repeater; (d) transmitting an image packet output from the remote management device to the repeater, wherein the image packet is derived from an image signal output from the at least one controlled computer to the remote management device; and (e) forwarding by the repeater the image packet to the other one of the first and second management computers via a second network.

In accordance with a further aspect of the present invention, a remote management system is provided. The remote management system comprises at least one controlled computer outputting an output signal; a remote management device connected to the at least one controlled computer, and converting the output signal into a network packet; and at least two management computers connected to the remote management device for managing the at least controlled computer, wherein one of the management computers is selected as a repeater for receiving the network packet from the remote management device and forwarding the network packet to the other one of the at least two management computer.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a diagram showing the arrangement of KVM over IP system known in this field.

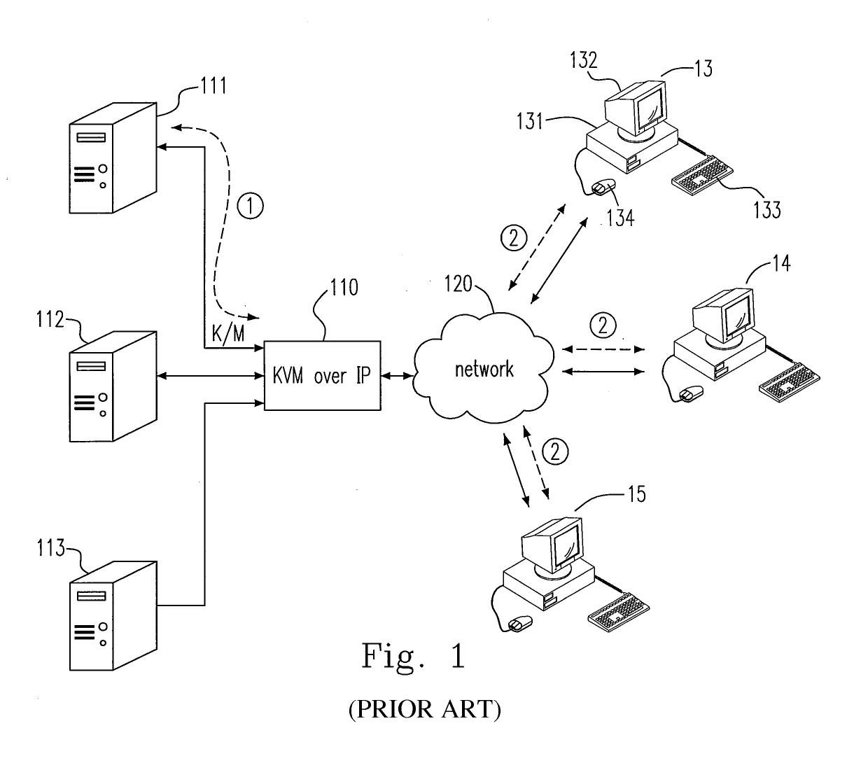

FIG. 2 is a diagram showing a remote management system according to a preferred embodiment of the present invention.

FIG. 3 is a diagram showing a remote management system according to another preferred embodiment of the present invention.

FIG. 4 is a flow chart showing a preferred embodiment of the present invention for selecting a backup management device.

FIG. 5 shows a preferred embodiment of the present invention for generating an order of selecting the backup management device.

FIG. 6 is a flow chart showing the process of the log-in of a management computer into a backup management device according to a preferred embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

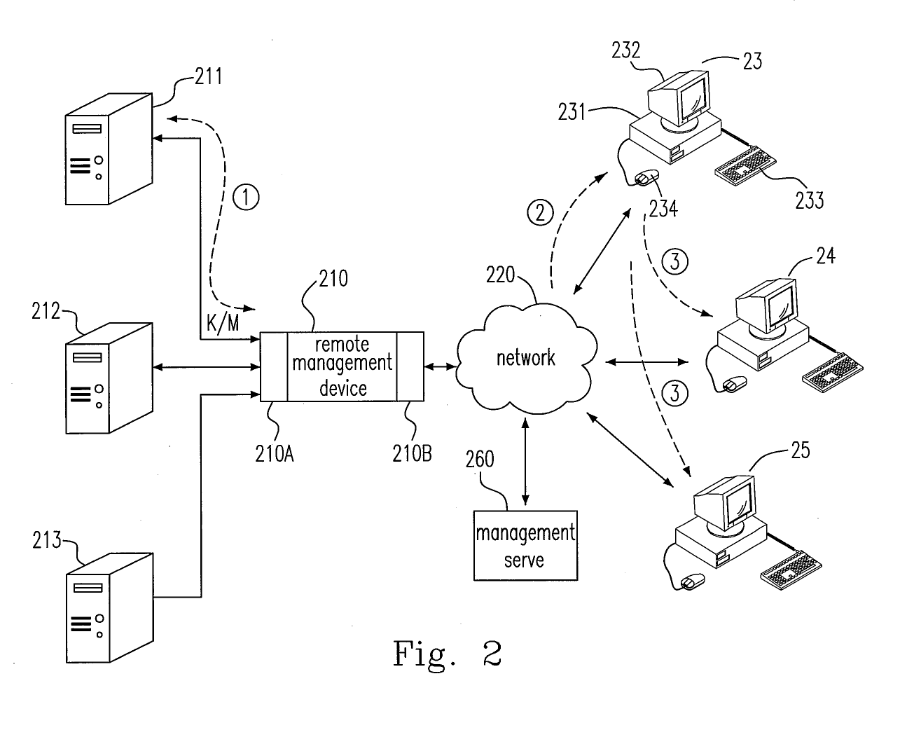

Referring to FIG. 2, there is shown a diagram showing a remote management system according to a preferred embodiment of the present invention. The remote management system has a remote management device 210, such as a keyboard-Video-Mouse Switch (KVM) or a so-called KVM over IP device, connected to one or more controlled computers 211-213 via a computer interface 210A. The remote management device 210 is also connected to a plurality of management computers, such as a first management computer 23, a second management computer 24 and a third management computer 25, by a proper network interface 210B through a network 220. The computer interface 210A may have one or more ports, and there may be an adapter between the computer interface 210A and each controlled computer 211-213 for extending the distance between the computer interface 210A and each controlled computer 211-213. The extended mentioned distance may be up to 300 to 1,000 ft. The network 220 is usually an Internet, a local network or the combination thereof. In a preferred embodiment, the “hardware” framework of the remote management device 210 may be based on Product Model Nos. CN6000, CN8000, KH1508i, KH1516i, KN9108, KN9116 and so on, provided by ATEN INTERNATIONAL CO., LTD.

Because of the remote management device 210, each management computer 23, 24 or 25 that has logged-in can transmit control signals thereof, such as a keyboard/mouse signal K/M, via the network 220 to a selected controlled computer in a form of the network packet, so as to control the selected controlled computer, such as the controlled computer 211 in FIG. 2. The remote management device 210 administers the authority that each management computer 23, 24 or 25 has for managing the controlled computers 211, 212 and 213.

Take the first management computer 23 as an example. Each management computer includes a computer mainframe 231, a displayer 232, a keyboard 233 and a mouse 234. The first management computer 23 is configured with a first management program (not shown), which may be a KVM management program, provided by the supplier of the remote management device 210 and performing in the first management computer 23, so that the first management computer 23 can perform the network communication with the remote management device 210 via the network 220 and the network interface 210B. After the first management computer is logged into, the first management program transmits a control signal (such as the keyboard /mouse signal K/M) output by the first management computer 23 via the network 220 to the remote management device 210 in the form of the network packet for managing the remote management device 210 and the controlled computer 211. The remote management device 210 will first determine whether the first management computer 23 has the authority to manage the controlled computer 211. If yes, the remote management device 210 will transmit the control signal sent from the first management computer 23 to the controlled computer 211 via the computer interface 210A according to the authority thereof. The controlled computer 211, upon receiving the control signal, will sent the information (such as an image signal) to the remote management device 210 according to the command required by the management computer 23 via the computer interface 210A over the path shown by the dotted line (1). The remote management device 210 then converts the received image signal into the network packet, and then transmits the network packet via the network interface 210B through the network 220 to the management computer 23 that issued the command over the path shown by the dotted line (2). Finally, the image signal will be processed by the management computer (such as opening or decompressing the network packet) and shown on the displayer 232. Similarly, the other management computers 24 and 25 are respectively configured with the second and the third management programs (not shown), which functions are the same as that of the first management program, and manage the controlled computer 211, 212 or 213 in the same manner, i.e. by the remote management device 210.

If two or more management computers are connected or switched to the same port of the remote management device 210, then it indicates that there are two management computer sets connected to the same controlled computer at the same time. For example, when the first management computer 23 is connected to a certain port of the remote management device 210 via the network, and the second management computer 24 is connected to the same port of the remote management device 210 via the network at the same time, the remote management device 210 according to the present invention can select one of them as a backup management device, i.e., a repeater. In a preferred embodiment, if the performance of the first management computer 23 is better than that of the second management computer 24, the remote management device 210 will select the first management computer 23 as the backup management device, send a set of time-limited identification codes to the second management computer 24, and inform the first management computer 23 of the set of the time-limited identification codes. After the second management program operated in the second management computer 24 receives the identification code, the second management computer 24 will transmit a message for requesting a connection through the network 220 to the first management computer 23 that is selected as a backup management device, and provide the set of the time-limited identification codes to the first management computer 23 for verification. While under the operation of the first management program, the first management computer 23 will determine whether the second management computer 24 matches the information on a stored list, and whether the second management computer 24 has a management authority to manage the controlled computer 211. The first management computer 23 will also determine whether to forward the network packet obtained from the remote management device 210 to the second management computer 24 based on the identification codes. If the above determination result is positive, a network connection will be established between the first management computer 23 and the second management computer 24. After establishing the network connection, the first management computer 23 will transmit the message, such as the network packet, obtained from the controlled computer 211 to the second management computer 24 through the network 220 along the path shown by the dotted line (3). In this manner, the first management computer 23 can be the repeater between the remote management device 210 and the second management computer 24, and therefore it is unnecessary for the remote management device 210 to transmit the network packet to the second management computer 24 directly. On the other hand, the control signal transmitted from the keyboard or mouse of the second management computer 24 to the remote management device 210 is not required to be passed through the first management computer 23.

In addition, if a third management computer 25 requests to be switched to the same port of the remote management device 210 at the same time or later, the remote management device 210 will send another set of the identification codes to the third management computer 25. If the first management computer 23 is still selected as the repeater, the first management computer 23 will determine, based on the identification codes, whether to forward the network packet obtained from the remote management device 210 to the third management computer 25 as well. Alternatively, among the first to third management computers, the first management computer 23 can be the first-priority repeater because of the best performance, and the second management computer 24 can be the second-priority repeater if its performance is better than that of the third management computer 25.

As shown in FIG. 2, the remote management system according to the present invention may further include a management server 260. The aforementioned remote management system may also manage the remote management device 210 by using the management server 260 through the connection of the network 220, so as to manage and set the management authorities of the computers 23-25 for the controlled computer 211. After the users of the management computers 23, 24 and 25 log into the management server 260, the users can manage the remote management device 210 and the controlled computers connected thereto based on their authorities. Although FIG. 2 merely shows one remote management device 210, according to the present invention, a management server 260 can manage a plurality of remote management devices at the same time.

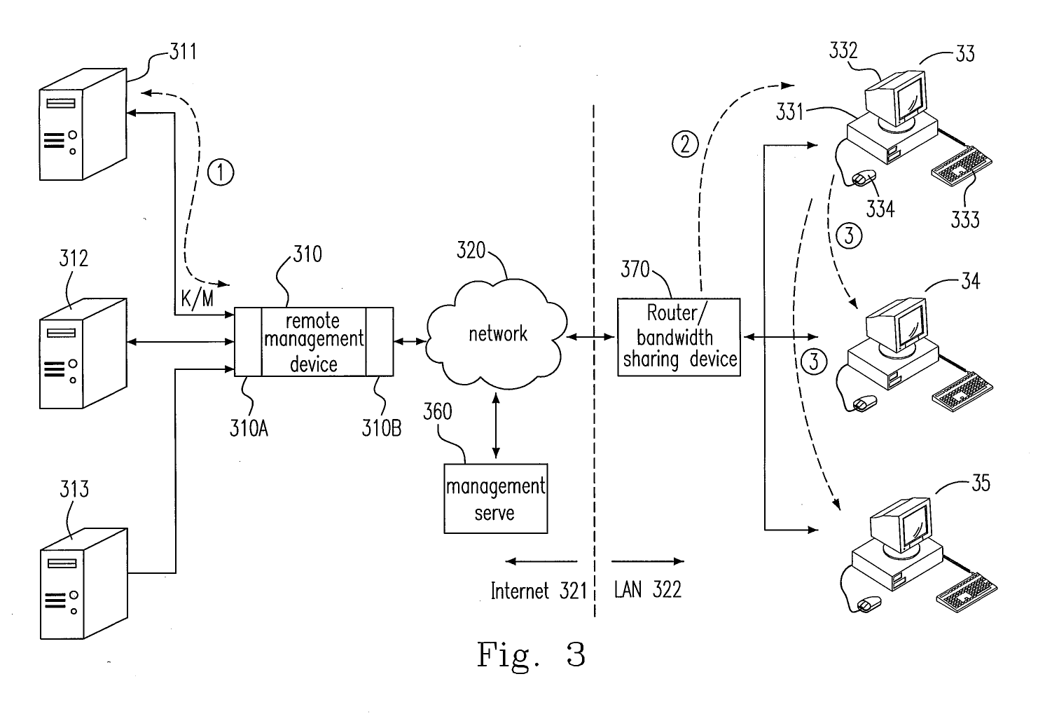

Referring to FIG. 3, there is shown a diagram of a remote management system according to another preferred embodiment of the present invention. In this embodiment, a plurality of management computers is connected to a same local area network (LAN). The remote management system has a remote management device 310, such as a network multi-computer switch (KVM over IP switch). The remote management device 310 is connected to at least one of controlled computers 311-313 via a computer interface 310A of the remote management device 310, and connected to a router (bandwidth sharing device) 370 of the LAN 322 through Internet 321 via an appropriate network interface 310B. The remote management device 310 is connected to a plurality of management computers 33-35, such as a first management computer 33, a second management computer 34 and a third management computer 35, through the LAN 322.

The management programs performed in the management computers 33-35 are all connected through the abovementioned network, so that the remote management device 310 can transmit a control signal K/M (such as the keyboard /mouse signal) to the controlled computer 311 for managing the controlled computer 311. Based on the operation process described herein, in response to the control signal K/M, the controlled computer 311 transmits information (such as an image signal) required by the management computers 33-35 to the remote management device 310 via the computer interface 310A via the transmission path shown by the dotted line (1). The remote management device 310 converts the image signal output by the controlled computer into a network packet, and then transmit the network packet to the router (also called bandwidth sharing device) 370 via the network interface 310B through the network 320 (Internet 321). Then, in LAN 322, the network packet is transmitted along the path shown by the dotted line (2) from the router 370 to the management computer that has generated and issued the request, such as the first management computer 33. If the remote management device 310 sets the first management computer 33 that receives the network packet as the backup management device (i.e., the repeater), it will sends a set of time-limited identification codes to each of the second management computer 34 and the third management computer 35, and informs the first management computer 33 of the sets of the time limited identification codes. After the management programs operated in the second and the third management computers 34, 35 receives the identification codes, the second and third management computers 34, 35 will transmit a message for requesting a connection through the LAN 322 to the first management computer that has been selected as the backup management device, and provide the sets of the time-limited identification codes to the first management computer 33 for the verification. The first management computer 33 will determine whether the second and the third management computers 34, 35 are in a certificated state based on the identification codes of the management computers 34, 35, and whether the second and the third management computers 34, 35 have management authorities to manage the controlled computer 311. If the above determination result is positive, the first management computer 33 will transmit the message, such as the image signal, obtained from the controlled computer 311 to the management computers 34, 35 through the LAN 322 along the path shown by the dotted line (3). In the preferred embodiment of the present invention, if the performance of the management computer 33 is better than those of the management computers 34, 35, the management computer 33 will be selected as the repeater, and the management computers 34, 35 will receive the message forwarded from the repeater. In this way, better transmission efficiency for the signal transmission can be achieved.

As shown in FIG. 3, the remote management system according to the present invention may further include a management server 360. In this embodiment, the management server 360 can manage the remote management device 310 through the Internet 321, so as to manage and set the management authorities of the management computers 33-35 for the controlled computer 311. After the users of the management computers 33, 34 and 35 log into the management server 360, the users can manage the remote management device 310 and the controlled computers connected thereto based on their authorities.

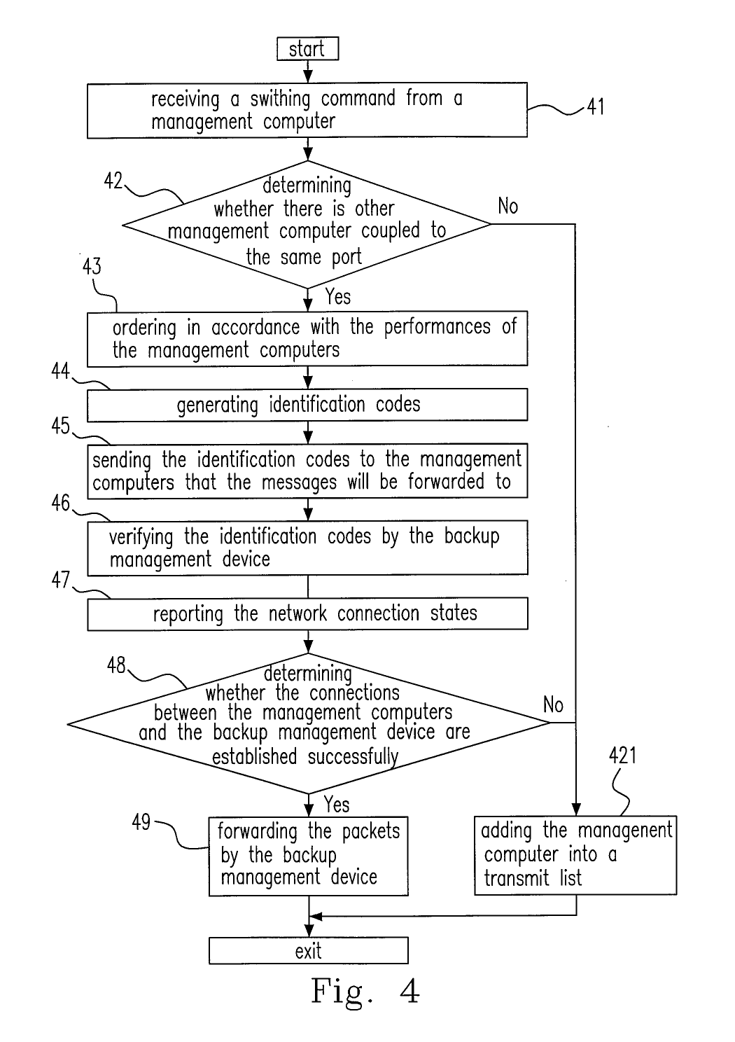

Referring to FIG. 4, there is shown a flow chart of a preferred embodiment of the present invention for selecting a backup management device by a firmware of the remote management device. When the management computer 25 sends a switching command to the remote management device 210 for switching to a controlled computer 211 and there is no other management computer connected to the controlled computer 211 (steps 41, 42), the remote management device 210 will add the management computer 25 into a transmit list (step 421). When two or more management computers are connected to the same controlled computer at the same time, i.e., they are connected to a same port of the remote management device , the remote management device 210 will estimate the performances of the management computers based on their CPU performance, image processing ability, dynamic random access memory capacity, network chip performance or any combination thereof, and generate an order of selecting a repeater in accordance with the merits of the performances (step 43).

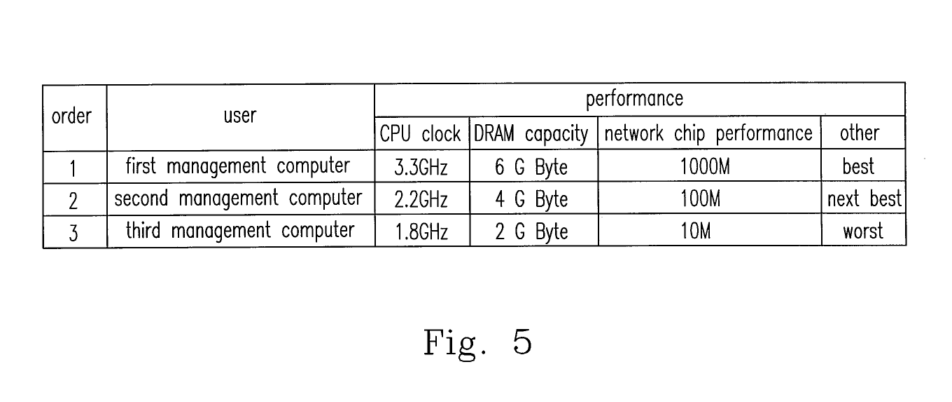

Referring to FIG. 5, there is shown an example in which an order is generated according to the abovementioned method. In this example, the first management computer 23 has the best performance. Alternatively, the remote management device 210 can determine the order of selecting the backup management device (i.e., the repeater) based on the current CPU loading or usage of each of the management computers. For instance, if the CPU loading of first management computer 23 is 10%, the CPU loading of second management computer 24 is 20%, and the CPU loading of the third management computer 25 is 30%, the first management computer 23 has the highest priority on the order of being selected as the backup management device; the next one is the second management computer 24; and the last one is the third management computer 25.

Alternatively, the remote management device 210 can determine the order of selecting the backup management device according to the network link rates of the plurality of management computers when the requirements thereof are output. Alternatively, the order of determining the backup management device can be determined by a certain management computer when it outputs a requirement according to the network link rates of itself and the other management computers, rather than being provided by the remote management device 210. Said network link rates may be determined, for example, in a manner that the management computers transmit a plurality of network packets to each other, and the required time of receiving the acknowledge can be used to determine the network link rates of the management computers. For instance, if the third management computer 25 transmits a plurality of network packets to the first management computer 23 and the second management computer 24, respectively, and the responding rate of the first management computer 23 is faster than that of the second management computer 24, the remote management device 210 or the third management computer 25 will preferably select the first management computer 23 as the repeater.

For the management computers that the message is forwarded thereto, the remote management device 210 will generate and transmit time-limited identification codes thereto, respectively (step 44, 45). The remote management device 210 will inform the management computer that has been selected as the backup management device (i.e., the repeater), such as the first management computer 23, of the abovementioned identification codes, so that the first management computer 23 can verify the other management computers 24, 25 based on the identification codes (step 46). Once the process of the network connections between the management computer being the backup management device and the other management computers is achieved, the management programs operated in the respective management computers will make their individual management computers to report the network connection results or states to the remote management device 210 (step 47). If the remote management device confirms that the connections are established successfully (step 48), the remote management device 210 will manage the management computer used as the backup management device, such as the first management computer 23, to receive the network packet from the remote management device 210 and forward the network packet to the other management computers (step 49).

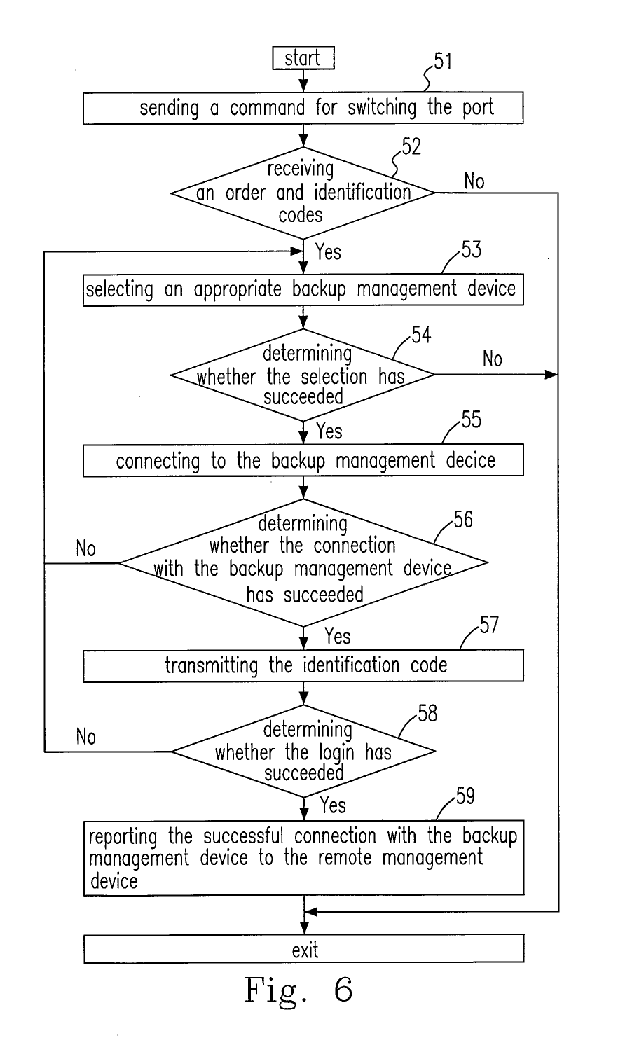

Referring to FIG. 6, there is shown a flow chart of the log-in process of a management computer into a backup management device according to a preferred embodiment of the present invention. For example, when the third management computer 25 sends a command to the remote management device 210 for switching to the controlled computer 211 that both the first management computer 23 and the second management computer 24 are coupled to (step 51), the remote management device 210 will determine the management authority of the third management computer 25 for the controlled computer 211 and provide the identification codes showing the management authority for the controlled computer 211 and the performance order of the first management computer 23 and the second management computer 24 to the third management computer 25. For example, the order may indicate that the first management computer 23 has a better performance than the second management computer 24. Of course, if the order does not exist, the third management computer 25 has to obtain the image signal of the controlled computer 211 directly by the remote management device 210. If the third management computer 25 receives the identification codes and the order (step 52), it will select an appropriate backup management device from the computers in the order (step 53). If the selection has succeeded (step 54), for example, the first management computer 23 is the first choice in the order, the third management computer 25 will first send the message of requesting the connection to the first management computer 23 (step 55). After determining that the network connection between the third management computer 25 and first management computer 23 has succeeded (step 56), the third management computer 25 transmits its identification codes to the first management computer 23 (step 57). After the first management computer 23 determines the management authority of the third management computer 25 for the controlled computer 211, the third management computer 25 logs-in as a user thereof (step 58). Finally, the third management computer 25 reports the aforementioned successful connection with the backup management device to the remote management device 210 through the network (step 59), and the remote management device 210 thereafter will forward the messages coming from the controlled computer 211 to the third management computer 25 through the first management computer 23. In this manner, the third management computer 25 can obtain the image signals output by the controlled computer 211 not directly from the remote management device 210. If the network connection between the third management computer 25 and first management computer 23 in step 56 does not succeed, the process will be back to step 53, and the third management computer 25 will resume selecting a suitable backup management device based on the order. If the selection in step 54 does not succeed, there may be no other management computer available to be selected as a backup management device. In this case, the third management computer 25 can obtain the image signals of the controlled computer 211 directly from the remote management device 210.

It is to be noted that the operation processes related to the aforementioned management computers 23-25 and 33-35 are performed under the operations of the management programs provided by the present invention. The aforementioned management computers 23-25 and 33-35 may be personal computers, notebook computers or portable computers, severs, or electronic devices having the same general functions and/or specifications. The controlled computer 211-213 and 311-313 may be computers, servers or devices having the same general functions and/or specifications.

While the invention has been described in terms of what is presently considered to be the most practical and preferred embodiments, it is to be understood that the invention needs not be limited to the disclose embodiments. Therefore, it is intended to cover various modifications and similar arrangements included within the spirit and scope of the appended claims, which are to be accorded with the broadest interpretation so as to encompass all such modifications and similar structures.

What is claimed is:

1. A remote management system, comprising:
a remote management device having a network interface and a computer interface connected to at least one controlled computer, for converting an image signal output by the at least one controlled computer through the computer interface into a network packet;
a first management program executable on a first management computer, the first management program when executed on the first management computer causing the first management computer to output a first control signal and establish a network connection between the first management computer and the remote management device through a first network and the network interface, and transmit the first control signal to the remote management device via the first network for managing the at least one controlled computer; and
a second management program executable on a second management computer, the second management program when executed on the second management computer cause the second management computer to output a second control signal and establish a network connection between the second management computer and the remote management device through the first network and the network interface, and transmit the second control signal to the remote management device via the first network for managing the controlled computer,
wherein one of the first and second management computers is selected as a repeater for receiving the network packet from the remote management device and forwarding the network packet to the other one of the first and second management computers via a second network.

2. A remote management system as claimed in claim 1, wherein the remote management device manages a first management authority of the first management computer and a second management authority of the second management computer for the at least one controlled computer, and the repeater determines whether the other one of the first and second management computers has management authority to manage the at least one controlled computer before forwarding the network packet to the other one of the first and second management computers.

3. A remote management system as claimed in claim 2, wherein the remote management device sends an identification code to the other one of the first and second management computers, and the repeater determines whether the other one of the first and second management computers has the management authority based on the identification code.

4. A remote management system as claimed in claim 3, wherein the identification code has a time limit.

5. A remote management system as claimed in claim 2, further comprising a management server managing the remote management device, and thereby managing the first and second management authorities.

6. A remote management system as claimed in claim 1, wherein when one of the first and second management computers has a performance better than the other one of the first and second management computers, the one of the first and second management computers having a better performance is selected as the repeater.

7. A remote management system as claimed in claim 6, wherein the performance is estimated based on one or more of the factors or their combinations selected from a group consisting of CPU performance, image processing ability, memory capacity, and network chip performance.

8. A remote management system as claimed in claim 6, wherein the remote management device generates an order of selecting the repeater according to the performance.

9. A remote management system as claimed in claim 1, wherein the remote management device estimates a CPU usage of each of the first and second management computers and selects the repeater based on the estimated CPU usage.

10. A remote management system as claimed in claim 1, wherein the first and second management computers each further comprises a display, a keyboard and a mouse, and its control signal is output by one of its keyboard and mouse.

11. A remote management system as claimed in claim 1, wherein the first network is one of an Internet and a local area network.

12. A remote management system as claimed in claim 1, wherein the second network is one of an Internet and a local area network.

13. A remote management method, comprising steps of:
a. connecting at least one controlled computer to a remote management device;
b. coupling a first management computer and a second management computer to the remote management device via a first network, and managing the at least one controlled computer by the first management computer and the second management computer through the remote management device;
c. selecting one of the first and second management computers as a repeater;
d. transmitting an image packet output from the remote management device to the repeater, wherein the image packet is derived from an image signal output from the at least one controlled computer to the remote management device; and
e. forwarding by the repeater the image packet to the other one of the first and second management computers via a second network.

14. A remote management method as claimed in claim 13, before the step “e”, further comprising a step of:
e′. determining whether the other one of the first and second management computers has a management authority to manage the controlled computer.

15. A remote management method as claimed in claim 13, before the step “e”, further comprising steps of:
e-1. sending an identification code from the remote management device to the other one of the first and second management computers;
e-2. sending a request and the identification code from the other one of the first and second management computers to the repeater; and
e-3. in response to the request, determining by the repeater whether the other one of the first and second management computers has management authority for the controlled computer based on the identification code.

16. A remote management method as claimed in claim 13, wherein the step “c” comprises sub-steps of:
c-1. comparing performances between the first and second management computers; and
c-2. selecting the repeater based on the compared performances.

17. A remote management method as claimed in claim 16, wherein the step “c” further comprises a sub-step of:
c-2. generating an order of selecting the repeater based on the compared performances.

18. A remote management method as claimed in claim 13, wherein the step “c” comprises sub-steps of:
c-1. estimating a CPU usage of each of the first and second management computers by the remote management device; and
c-2. selecting the repeater based on the estimated CPU usage.

19. A remote management system as claimed in claim 13, wherein the first network is one of an Internet and a local area network.

20. A remote management system as claimed in claim 13, wherein the second network is one of an Internet and a local area network.

21. A remote management system, comprising:
at least one controlled computer outputting an output signal;
a remote management device connected to the at least one controlled computer and converting the output signal into a network packet; and
at least two management computers connected to the remote management device for managing the at least one controlled computer,
wherein one of the management computers is selected as a repeater for receiving the network packet from the remote management device and forwarding the network packet to the other one of the at least two management computers.

22. A remote management system as claimed in claim 21, wherein each of the management computers outputs and transmits a control signal to the remote management device via a first network for managing the at least one controlled computer.

23. A remote management system as claimed in claim 21, wherein the repeater forwards the network packet to the other one of the at least two management computers via a second network.
